(19) United States
(12) Patent Application Publication
(10) Pub. No.: US 2025/0340697 A1
(43) Pub. Date: Nov. 6, 2025

(54) METHOD FOR THE MANUFACTURE OF POLYCARBONATE

(71) Applicant: SABIC GLOBAL TECHNOLOGIES B.V., Bergen op Zoom (NL)

(72) Inventors: David Del Agua Hernández, Murcia (ES); Dwairath Dhar, Bangalore (IN)

(21) Appl. No.: 18/870,984

(22) PCT Filed: Jun. 5, 2023
(86) PCT No.: PCT/EP2023/064961

§ 371 Date: Dec. 2, 2024

(30) Foreign Application Priority Data
Jun. 3, 2022 (EP) 22382538.1

(51) Int. Cl. C08G 64/30; C08G 64/40; C08K 5/3475

(52) U.S. Cl. CPC C08G 64/307; C08G 64/40; C08K 5/3475

(57) ABSTRACT

The present invention relates to the use of an ultraviolet stabilising compound comprising at least one benzotriazole group as a heat stabiliser in polycarbonate manufactured by means of a melt transesterification process comprising reacting diaryl carbonate and bisphenol catalysed by a catalyst and quenching the catalyst with a quencher.

The present invention relates to the use of an ultraviolet stabilising compound comprising at least one benzotriazole group in polycarbonate, as well as a method for the manufacture of polycarbonate.

Polycarbonate is generally manufactured using two different technologies. In a first technology, known as the interfacial technology or interfacial process, phosgene is reacted with bisphenol A (BPA) in a liquid phase. In this process the aromatic polycarbonate chains will grow, i.e. the molecular weight increases, until the reaction is stopped by means of addition of a chain-terminating agent, also referred to as end-capping agent. Typically, such end-capping agents are mono-hydroxy compounds such for example phenol. Due to the nature of the interfacial technology end-capping levels of the aromatic polycarbonate are very high, which means that the aromatic polycarbonate obtained via the interfacial technology will have a relatively low amount of terminal hydroxyl groups at the end of the aromatic polycarbonate chains. Consequently, such aromatic polycarbonates generally have very good initial color as well as a long-term heat stability. At least part of the long term stability is ascribed to the absence of catalyst or catalyst residues which as these are normally removed from the reaction mixture prior to isolation of the polycarbonate polymer. Although this process produces the desired polymer, there are disadvantages associated with it. For example, phosgene is extremely toxic and hence results in safety concerns. In addition, methylene chloride, which is often used as a solvent in the interfacial process, raises environmental concerns. Polycarbonate manufactured with the interfacial process is referred to herein as interfacial polycarbonate.

Another well-known technology for the manufacture of aromatic polycarbonate is the so-called melt technology, sometimes also referred to as melt transesterification, melt process, or melt polycondensation technology. In the melt technology, or melt process, a bisphenol, typically bisphenol A (BPA), is reacted with a carbonate, typically diphenyl carbonate (DPC), in the melt phase. The reaction between DPC and BPA releases phenol, which needs to be removed from the reaction mixture in order to progress the polymerization reaction. Typically, the melt process is carried out in a number of stages with increasing temperatures and decreasing pressures until a desired molecular weight is obtained. Due to the nature of the melt process, the resulting aromatic polycarbonate typically has a significantly higher amount of terminal hydroxyl groups. Due to this, the obtained aromatic polycarbonate, in comparison with the interfacially manufactured aromatic polycarbonate, has a lower long term heat stability performance. Apart from the higher amount of free hydroxyl groups in melt polycarbonate the polycarbonate when leaving the final reactor still contains active catalyst. In order to improve the long term stability of the polycarbonate it is known to deactivate this catalyst using a catalyst deactivating compound, generally referred to as a quencher. Polycarbonate manufactured with the melt process is referred to herein as melt polycarbonate.

US 2018/371208 discloses an article formed from a composition comprising: a melt polycarbonate resin derived from diphenyl carbonate; and glycerol tristearate mixed with the melt polycarbonate resin, wherein the melt polycarbonate resin exhibits a melt volume rate of between about 18 cm³/10 minutes and about 22 cm³/10 minutes, wherein the composition melt polycarbonate resin exhibits a fries concentration below about 800 ppm, wherein the article formed from the composition exhibits an Izod impact performance between about 9.5 KJ/m² and about 13 KJ/m² based on ISO 180 at 4 mm thickness at room temperature, and wherein the article formed from the composition exhibits weathering values of less than about 12 Delta Yellowness Index for an exposure time of 2000 hours when tested in accordance with ISO 4892.

US 2019/382557 discloses a molded article comprising: a polycarbonate resin produced by an interfacial polymerization process and having an endcap level of at least about 98%; an ultraviolet (UV) absorbing component; a heat stabilizer component; and an acid stabilizer component, wherein the molded article comprises a ratio of bound UV absorbing component to free UV absorbing component of less than about 1.0 when molded under abusive molding conditions.

US 2004/063825 discloses an aromatic-aliphatic copolycarbonate resin composition comprising 100 parts by weight of an aromatic-aliphatic copolycarbonate, 0.001 to 0.5 part by weight of a benzotriazole ultraviolet absorbent, and 0.005 to 0.1 part by weight of at least one of phosphorus antioxidants represented by the following formulae (1) to (3)

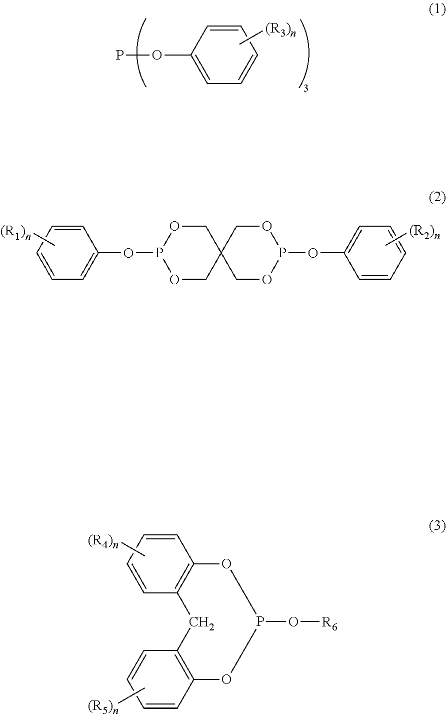

(wherein R₁ to R₆ represent a hydrogen atom, an alkyl group having 1 to 18 carbon atoms, or an oxy-alkyl group having 1 to 18 carbon atoms, provided that R₁ to R₆ may be the same or different; and n represents the number of substituents and is an integer of 0 to 4).

US 2016/362537 discloses a method for making a thermoplastic composition, comprising melt polymerizing a polycarbonate, extruding and melt filtering the polycarbonate to form a melt filtered polycarbonate; forming the thermoplastic composition comprising the melt filtered polycarbonate, 0.03 to 0.05 wt % of a triacylglyceride release agent; and 0.10 to 0.14 wt % of a UV stabilizer; wherein the weight percentages are based on the total weight of the composition; and extruding the thermoplastic composition.

The present inventors have observed that the addition of quencher to the melt polycarbonate results in a higher initial color value, also referred to herein as the a* value or the “cookie value”. Thus, the present inventors have observed that a higher amount of quencher results in a higher a* value.

In view of the foregoing it is an object of the present invention to provide for a polycarbonate having not only a good initial color value but also a long term color stability.

To that extent the present inventors surprisingly found that the addition of a relatively small amount of a ultra-violet (UV) stabilising compound, also referred to as UV stabiliser, having a benzotriazole group surprisingly results in a lower initial color value.

Accordingly the present invention relates to the use of an ultraviolet stabilising compound comprising at least one benzotriazole group as a heat stabiliser in polycarbonate manufactured by means of a melt transesterification process comprising reacting diaryl carbonate and bisphenol catalysed by a catalyst and quenching the catalyst with a quencher.

More in particular the present invention relates to the use of an ultraviolet stabilising compound comprising at least one benzotriazole group as an additive in polycarbonate manufactured by means of a melt transesterification process comprising reacting diaryl carbonate and bisphenol catalysed by a catalyst and quenching the catalyst with a quencher, for the manufacture of an article having an a* value which is lower compared to an otherwise identical polycarbonate not comprising said compound.

In accordance with the invention the method for the manufacture of polycarbonate comprises:
reacting diaryl carbonate and bisphenol catalysed by a catalyst in at least two consecutive reactors so as to form a stream of molten polycarbonate,
adding a quencher and an ultraviolet stabilising compound comprising at least one benzotriazole group to said molten stream of polycarbonate,
extruding the molten stream of polycarbonate into one or more strands
optionally cooling the one or more strands
pelletising the strands,
wherein the molar ratio of quencher to catalyst is from 0.9 to 10.0, preferably from 1.0 to 5.0, more preferably from 1.0 to 2.0 and wherein the amount of said ultraviolet stabilising compound is from 500 to 5000 ppm by weight on the basis of the weight of the polycarbonate.

### Polycarbonate

The polycarbonate is preferably an aromatic polycarbonate obtained by reacting bisphenol and diarylcarbonate, wherein the bisphenol is preferably bisphenol A (BPA) and the diarylcarbonate is preferably diphenyl carbonate (DPC). Other types of bisphenols and/or mixtures of bisphenol A and another bisphenol may also be used. The aromatic polycarbonate is preferably a linear aromatic polycarbonate meaning that the melt transesterification is carried out on the basis of the bisphenol and diarylcarbonate in absence of any branching agent, such as for example multi-functional alcohols. For the purpose of the present invention, the melt polycarbonate may however be branched or linear.

Notwithstanding the foregoing it is well known that the melt transesterification process for the manufacture of polycarbonate, wherein BPA and DPC are reacted in molten conditions thereby releasing phenol, results in a certain amount of branching, known as Fries branching. The amount of Fries branching depends inter alia on the type and amount of transesterification catalyst that is used as well as the reaction conditions that are applied, in particular the temperature, pressure and residence times. Thus, a linear polycarbonate in the context of the present invention will contain a certain amount of Fries branching. It is however to be understood that the polycarbonate in the present invention is preferably manufactured in absence of a branching agent, i.e. in absence of an agent that includes three or more functional groups which introduces branching or even cross-linking of the polycarbonate.

The polycarbonate is preferably a bisphenol A polycarbonate homopolymer.

The amount of Fries branching may be from 300 to 3000 ppm, preferably from 500-2000 ppm, more preferably from 600-1200 ppm. The term Fries branching is known to the skilled person and refers inter alia to the structures as disclosed in EP2174970 and reproduced below as structures (1) to (5), yet may include further branched structures.

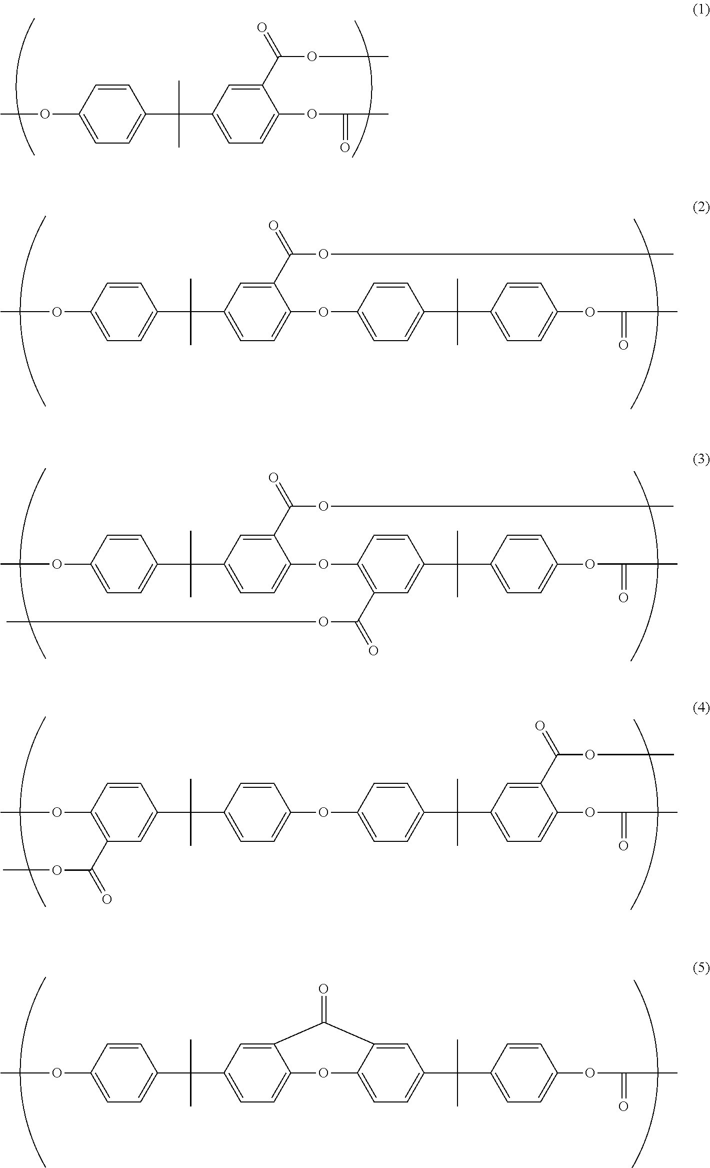

WO 2011/120921 discloses that units such as disclosed in EP 217940 are Fries branching species. Methods for determining the amount of Fries branching are known to the skilled person and generally include the methanolysis of the polycarbonate followed by HPLC chromatography to identify the total amount of Fries structures. In addition, NMR techniques can be used to determine the type and amount of these Fries structures, such as the respective amounts of linear and branched Fries structures.

It is preferred that the polycarbonate has a weight average molecular weight, Mw, of from 15,000 to 60,000 g/mol, determined by GPC on the basis of polystyrene standards. It is preferred that the polycarbonate has a melt volume rate (MVR) of from 3-30 cc/10 min as determined in accordance with ISO 1133 (300° C., 1.2 kg).

### Method

The method for the manufacture of the melt polycarbonate is not limited per se. In general the melt process involves the use of multiple reactors wherein generally increasing temperatures and lower pressures are applied in order to allow the condensation reaction to proceed by removal of the condensation by-product, which is typically phenol. The higher temperatures are used not only to advance the reaction but also to cope with the ever increasing viscosity of the polymer that is being formed. Thus, the method disclosed herein concerns a multi-stage process for the manufacture of polycarbonate comprising a monomer mixing stage, an oligomerisation stage and a polymerisation stage. The process may however include further stages such as in particular a finishing stage where the polycarbonate obtained from the polymerisation stage is fed to an extruder, extruded to strands which are then consecutively cut into pellets. The extruder provides the possibility to add further materials to the polycarbonate received directly from the final reactor.

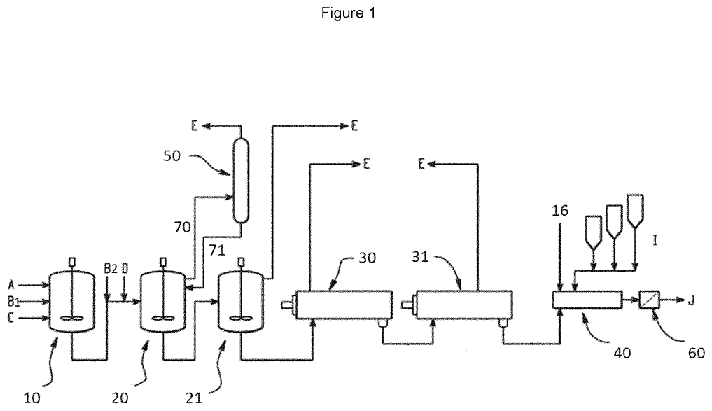

It is preferred that the polycarbonate is manufactured using a method and apparatus schematically shown in FIG. 1 which should however not to be considered as limiting the present invention. The following description will be on the basis of BPA and DPC as the raw materials, yet the skilled person will understand that this description equally applies to other types of bisphenol, bisphenol mixtures, other types of diaryl carbonates and diaryl carbonate mixtures.

The monomer mixing stage comprises the mixing of the monomers, i.e. the bisphenol and diaryl carbonate, or more specifically the BPA and DPC. The plant for the manufacture of polycarbonate may be part of an integrated site and the BPA and DPC may come directly from the plants on-site which produce the monomers either in solid or in molten form. The invention is however not limited to such an embodiment and BPA and DPC (or any other bisphenol and diaryl carbonate) may also be obtained from external sources and added to the equipment in the monomer mixing stage using appropriate feeding equipment and upon application of any optional pre-treatment such as melting, filtering, purification, solvent removal etcetera.

With reference to FIG. 1, BPA and DPC are added as streams A and B1 respectively to monomer mixing device 10. The DPC to BPA ratio in the monomer mixing device is kept fixed. A beta catalyst is added to monomer mixing device 10 via stream C. The monomer mixing device is equipped with a suitable stirrer so as to guarantee an even concentration of the components in the device. Monomer mixing device 10 can be maintained at a temperature of from 160 to 180° C. and at substantially atmospheric pressure. The stream exiting monomer mixing device 10 is fed to a first oligomerisation reactor 20. For reasons of process flexibility an additional amount of DPC is optionally added as stream B2. An alpha catalyst is added as a stream D. This monomer mixture is allowed to react for a certain time in oligomerisation reactor 20 of the oligomerisation stage. Generally oligomerisation reactor 20 is a continuous stirred tank reactor.

Oligomerisation reactor 20 operates at a temperature of from 230 to 260° C. and a pressure of from 140 to 200 millibar. An overhead stream comprising phenol byproduct and optionally monomers or other low molecular weight reaction products is removed via stream 70 and fed to column 50, which separates the phenol from the overhead stream. The phenol is then removed via top stream E for further purification and/or use, while the bottom stream is optionally fed back to reactor 20 as stream 71. The bottom portion of column 50 may also be further purified off-line or may be purged.

The mixture exiting reactor 20 is fed to a second oligomerisation reactor 21 for further reaction. Second oligomerisation reactor 21 operates at temperature of from 270 to 290° C. and a pressure of from 30 to 50 millibar. Phenol byproduct is removed from second reactor 21 as a stream E. Second oligomerisation reactor 20 may also be a continuous stirred tank reactor.

Oligomerisation reactors 20 and 21 constitute the oligomerisation stage, resulting in a stream of polycarbonate oligomer which is fed to first polymerisation reactor 30 and then to second polymerisation reactor 31. Reactor 30 operates at a temperature of from 290 to 315° C. and a pressure of 1 to 5 millibar. The stream from the first polymerisation reactor 30 is then fed to a second polymerisation reactor 31 that operates at temperature of from 290 to 315° C. and a pressure of from 0.3 to 1.5 millibar. The temperature in reactor 31 is generally higher than in reactor 30 and the pressure in reactor 31 is generally lower than the pressure in reactor 30. Similar to the oligomerisation stage phenol byproduct is removed from the reactors 30 and 31. Polymerisation reactors 30 and 31 together constitute the polymerisation stage. Different type of reactors may be applied as known to a person skilled in the art.

The polymer exiting second polymerisation reactor 31 is fed to extruder 40 where it is combined with one or more additives, indicated with I. A stream of catalyst deactivator, or quencher, is added via stream 16. The extruded stream is passed through a melt filter 60 and then extruded to strands and cut to pellets. For the avoidance of doubt it is noted that the position for addition of catalyst quencher is not limited to stream 16 and other positions may be equally suitable. The quencher may be combined with the polycarbonate upstream, downstream or together with the additives. The additive comprises the ultraviolet stabilising compound comprising at least one benzotriazole group as disclosed herein.

The additive stream may also comprise a stream of (mechanically) recycled polycarbonate, preferably in the form of pellets or powder, and wherein preferably the ultraviolet stabilising compound comprising at least one benzotriazole group is comprised in said recycled polycarbonate. In other words, the ultraviolet stabilising compound comprising at least one benzotriazole group may be combined with the polycarbonate in the extruder by means of a masterbatch comprising or consisting of recycled polycarbonate as a carrier resin, said carrier resin comprising said ultraviolet stabilising compound. Thus, it is preferred that in the method disclosed herein the polycarbonate is fed from a final reactor to an extruder and wherein an amount of recycled polycarbonate is combined with said polycarbonate in said extruder, said ultraviolet stabilising compound being contained, at least in part, in said recycled polycarbonate.

The ultraviolet stabilising compound comprising at least one benzotriazole group may also be added as a separate stream.

It is noted that while FIG. 1 illustrates polymerisation reactors 30 and 31 to be horizontal polymerisation units, these reactors may likewise each independently be vertical reactors such as the known wire wetting fall polymerisation type reactors.

The process indicated in FIG. 1 is shown as a single production line. It is however possible that at any point during the process the line is split into two or more parallel lines wherein each line operates at the same or different conditions including monomer mixture composition, temperature, pressure residence time etc. By way of example the stream exiting oligomerisation reactor 21 may be split into two or more different streams after which each stream is polymerised in one or more polymerisation reactors using, by way of example, different conditions resulting in the parallel manufacture of different grades of polycarbonate. Another possibility is to split the stream exiting the final polymerisation reactor 31 and then to feed the polycarbonate stream to different extruders. An option in such embodiment is to add a chain scission agent via stream 16 and/or to use different additives in the extruder so as to manufacture different grades in parallel. Finally the monomer mixing device may supply any number of oligomerisation and polymerisation lines.

Apart from the specific configuration shown in FIG. 1 the method of the invention is carried out under one or more of the following preferred conditions.

It is preferred that the monomer mixing stage comprises addition of a beta catalyst wherein the beta catalyst is a quaternary ammonium or quaternary phosphonium compound or a mixture thereof.

### Beta Catalyst

The quaternary ammonium compound can be organic ammonium compound(s) having structure, (R1)₄N⁺X⁻, wherein each R1 is the same or different, and is a C₁-C₂₀ alkyl, a C₄-C₂₀ cycloalkyl, or a C₆-C₂₀ aryl; and X is an organic or inorganic anion, for example, a hydroxide, halide, carboxylate, sulfonate, sulfate, formate, carbonate, or bicarbonate. Some non-limiting examples of organic quaternary ammonium compounds include tetramethyl ammonium hydroxide, tetrabutyl ammonium hydroxide, tetramethyl ammonium acetate, tetramethyl ammonium formate, tetrabutyl ammonium acetate, and combinations comprising two or more of the foregoing. Tetramethyl ammonium hydroxide is often employed.

The quaternary phosphonium compound can be of organic phosphonium compounds having structure, (R2)₄P⁺X⁻, wherein each R2 is the same or different, and is a C₁₋₂₀ alkyl, a C₄-C₂₀ cycloalkyl, or a C₆-C₂₀ aryl; and X is an organic or inorganic anion, for example, a hydroxide, phenoxide, halide, carboxylate such as acetate or formate, sulfonate, sulfate, formate, carbonate, or bicarbonate. Where X⁻ is a polyvalent anion such as carbonate or sulfate, it is understood that the positive and negative charges in the quaternary ammonium and phosphonium structures are properly balanced. For example, where each R2 are independently methyl groups and X- is carbonate, it is understood that X⁻ represents 2(CO₃²⁻).

Examples of organic quaternary phosphonium compounds include tetramethyl phosphonium hydroxide, tetramethyl phosphonium acetate, tetramethyl phosphonium formate, tetrabutyl phosphonium hydroxide, tetraphenyl phosphonium acetate (TPPA), tetraphenyl phosphonium phenoxide (TPPP), tetraethyl phosphonium acetate, tetrapropyl phosphonium acetate, tetrabutyl phosphonium acetate (TBPA), tetrapentyl phosphonium acetate, tetrahexyl phosphonium acetate, tetraheptyl phosphonium acetate, tetraoctyl phosphonium acetate, tetradecyl phosphonium acetate, tetradodecyl phosphonium acetate, tetratolyl phosphonium acetate, tetramethyl phosphonium benzoate, tetraethyl phosphonium benzoate, tetrapropyl phosphonium benzoate, tetraphenyl phosphonium benzoate, tetraethyl phosphonium formate, tetrapropyl phosphonium formate, tetraphenyl phosphonium formate, tetramethyl phosphonium propionate, tetraethyl phosphonium propionate, tetrapropyl phosphonium propionate, tetramethyl phosphonium butyrate, tetraethyl phosphonium butyrate, and tetrapropyl phosphonium butyrate, and combinations comprising two or more of the foregoing.

The quaternary catalyst can comprise TPPP, TPPA, TBPA or a combination comprising one or both of the foregoing. In a preferred embodiment the beta catalyst, i.e. the quaternary catalyst, is tetrabutyl phosphonium acetate (TBPA).

The amount of quaternary catalyst employed is typically based upon the total number of moles of dihydroxy compound employed in the polymerisation reaction. When referring to the ratio of quaternary catalyst, for example, phosphonium salt, to all dihydroxy compounds employed in the polymerisation reaction, it is convenient to refer to moles of phosphonium salt per mole of the dihydroxy compound(s), meaning the number of moles of phosphonium salt divided by the sum of the moles of each individual dihydroxy compound present in the reaction mixture. The amount of beta catalyst, i.e. quaternary catalyst (e.g., organic ammonium or phosphonium salts) employed typically will be from 1×10⁻² to 1×10⁻⁵, specifically from 1×10⁻³ to 1×10⁻⁴ moles per total mole of the dihydroxy compounds in the reaction mixture.

The quaternary catalyst is preferably free of metal compounds, which may be present as impurities. In particular, the quaternary catalyst comprises at most 500 ppm preferably at most 50 ppm of sodium and at most 100, preferably at most 50 ppm of potassium, based on the total weight of the quaternary catalyst.

The quaternary catalyst can be added just upstream of and/or directly into a monomer mixing device and/or into an oligomerisation reactor.

### Alpha Catalyst

The alpha catalyst, which is an alkali containing catalyst comprises a source of one or both of alkali ions and alkaline earth ions. The sources of these ions can include alkaline earth hydroxides such as magnesium hydroxide and calcium hydroxide. Sources of alkali metal ions can include the alkali metal hydroxides such as lithium hydroxide, sodium hydroxide, potassium hydroxide, and combinations comprising two or more of the foregoing. Examples of alkaline earth metal hydroxides are calcium hydroxide, magnesium hydroxide, and combinations comprising two or more of the foregoing. The alkali catalyst can comprise sodium hydroxide. The alkali catalyst typically will be used in an amount sufficient to provide from 1×10⁻² to 1×10⁻⁸ moles, specifically from 1×10⁻⁴ to 1×10⁻⁷ moles of metal hydroxide per mole of the dihydroxy compounds employed.

Other possible sources of alkaline earth and alkali metal ions include salts of carboxylic acids (such as sodium acetate) and derivatives of ethylene diamine tetra-acetic acid (EDTA) (such as EDTA tetra-sodium salt, and EDTA magnesium disodium salt), as well as combinations comprising at least one of the foregoing. For example, the alkali catalyst can comprise alkali metal salt(s) of a carboxylic acid, alkaline earth metal salt(s) of a carboxylic acid, or a combination comprising at least one of the foregoing. In another example, the alkali catalyst comprises Na₂Mg EDTA or a salt thereof.

The alkali catalyst can also, or alternatively, comprise salt(s) of a non-volatile inorganic acid. For example, the alkali catalyst can comprise salt(s) of a non-volatile inorganic acid such as NaH₂PO₃, NaH₂PO₄, Na₂HPO₃, KH₂PO₄, CsH₂PO₄, Cs₂HPO₄, and combinations comprising two or more of the foregoing. Alternatively, or in addition, the alkali catalyst can comprise mixed alkali metal salt(s) of phosphoric acid, such as NaKHPO₄, CsNaHPO₄, CsKHPO₄, and combinations comprising two or more of the foregoing. The alkali catalyst can comprise KNaHP04, wherein a molar ratio of Na to K is 0.5 to 2.

The alkali catalyst is preferably added downstream of the monomer mixing device and can be added for example upstream of and/or directly to the one or more oligomerisation and/or polymerisation reactors.

Alkali catalysts, i.e. alpha catalysts, are transesterification catalysts that are typically more thermally stable than quaternary catalysts, i.e. beta catalysts, and therefore can be used throughout transesterification, including during oligomerisation, and after oligomerisation, e.g., in the polymerisation reactors, during polymerisation. Nearly all of the alkali catalyst (e.g., greater than 80 wt. %, specifically greater than 90 wt. %) survives the polymerisation process. As such, this catalyst is available to catalyze additional and generally undesired reactions downstream of the polymerisation process, such as in the extruder or even in post-processing of the obtained polycarbonate.

To suppress such further reactions a catalyst quencher can be added to deactivate, i.e. quench, the alkali catalyst. Accordingly the method of the invention comprises adding a quencher to the last of said polymerisation reactors and/or to said extruder for deactivating the catalyst, at least in part, in the polycarbonate. The quencher can comprise a sulfonic acid ester such as an alkyl sulfonic ester of the formula R3SO₃R4 wherein R3 is hydrogen, C₁-C₁₂ alkyl, C₆-C₁₈ aryl, or C₇-C₁₉ alkylaryl, and R4 is C₁-C₁₂ alkyl, C₆-C₁₈ aryl, or C₇-C₁₉ alkyl aryl. Examples of alkyl sulfonic esters include benzenesulfonate, p-toluenesulfonate, ethylbenzene sulfonate, n-butyl benzenesulfonate, octyl benzenesulfonate and phenyl benzenesulfonate, methyl p-toluenesulfonate, ethyl p-toluenesulfonate, n-butyl p-toluene sulfonate, octyl p-toluenesulfonate and phenyl p-toluenesulfonate. The sulfonic acid ester can comprise alkyl tosylates such as n-butyl tosylate.

The preferred amount of quencher is such that the molar ratio of quencher to catalyst is preferably from 0.9 to 10.0, preferably from 0.9 to 5.0 or 0.9-3.5, more preferably from 1.0 to 5.0, even more preferably from 1.0 to 3.5, even more preferably from 1.0 to 1.5. The amount of quencher is determined on the basis of the amount of alpha catalyst for the reason that beta catalysts typically don't survive the process conditions in the final polymerisation reaction.

Typically the amount of quencher added is from 0.5 to 5 ppm, preferably 0.5 to 2 ppm, more preferably from 0.5 to 1.5 ppm, more preferably from 0.8-1.2 ppm based on the weight of the polycarbonate. Higher amounts of quencher may result in poorer initial color of the obtained polycarbonate, i.e. a higher cookie value.

The quencher can be added as a liquid or a solid at one or more locations in the melt preparation of the polycarbonate. The quencher may be part of a composition further comprising a liquid carrier, a solid carrier or a solvent.

A preferred catalyst quencher is n-butyl tosylate.

In an embodiment the method according to the invention does not comprise the addition of an alpha catalyst and only the addition of a beta catalyst being a quaternary phosphonium compound such as in particular TPPP.

It is preferred that in the process for the manufacture of polycarbonate as disclosed herein in its several aspects no acid stabiliser, such as phosphorous acid, is added to the polycarbonate. Such acids may be added for the purpose of improving the heat stability. For the avoidance of doubt it is noted that the quencher, such as n-butyl-tosylate, is not to be considered as an acid stabiliser.

The monomer mixing stage is preferably carried out a temperature of from 100 to 250° C., specifically from 150 to 200° C., more specifically from 165 to 185° C. The pressure in the monomer mixing stage is preferably substantially atmospheric such as from 900 to 1100 mbar.

The oligomerisation stage is preferably carried out in two steps wherein in a first step the temperature is from 230 to 260° C. and the pressure is from 140 to 200 mbar, and wherein in a second step the temperature is higher than in the first step and from 260 to 290° C. and the pressure is from 30 to 50 mbar.

The weight average molecular weight of the oligomer resulting from the oligomerisation stage is preferably from at most 12000, preferably from 8000 to 12000 Daltons, determined on the basis of polystyrene standards.

The polymerisation stage is preferably carried out in two steps wherein in a first step the temperature is from 290 to 315° C. and the pressure is from 1 to 5 mbar and wherein in a second step the temperature is from 290° C. to 315° C. and the pressure is from 0.3 to 1.5 mbar.

As per the exemplified process of FIG. 1, it is preferred that the oligomerisation stage consists of preparing a carbonate oligomer in two oligomerisation reactors and wherein the polymerisation stage consists of preparing the polycarbonate in two polymerisation reactors.

It is further preferred that the method comprises a step of melt filtering the polycarbonate from the last of the polymerisation reactors and the feeding said polycarbonate to a finishing extruder.

In a preferred embodiment of method of the invention the bisphenol is bisphenol A, the diaryl carbonate is diphenyl carbonate, a beta catalyst is added in the monomer mixing stage and an alpha catalyst is added prior to feeding the monomer mixture prepared in the monomer mixing device to the first oligomerisation reactor.

In a preferred embodiment of method of the invention the bisphenol is bisphenol A, the diaryl carbonate is diphenyl carbonate, the alpha catalyst is NaKHPO₄ or NaOH, the beta catalyst is tetra-butyl phosphonium acetate and the quencher is n-butyl tosylate.

### Ultraviolet Stabiliser

The ultraviolet stabiliser in accordance with the aspects of the invention disclosed herein is preferably selected from the group consisting of

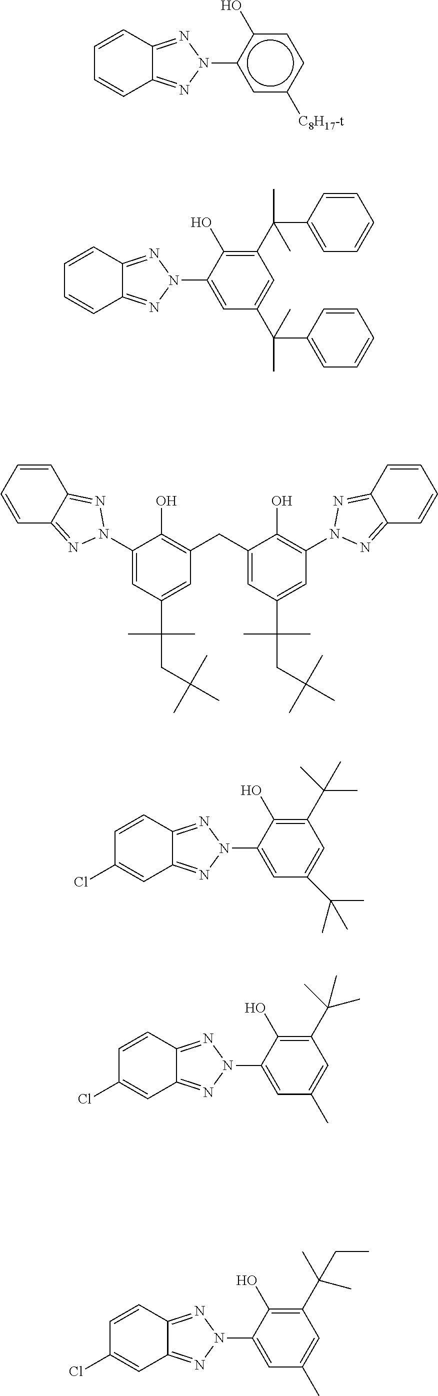

and combinations of two or more of these compounds.

The present invention also relates to an article comprising or consisting of the polycarbonate obtained or obtainable by the method disclosed herein.

Likewise the present invention relates to the manufacture of such an article comprising manufacturing polycarbonate according to the method disclosed herein and moulding the polycarbonate at a temperature of from 280-350° C., preferably at least 300° C., such as from 300-350° C. or 300-330° C. Moulding temperatures of at least 300° C. are preferred for polycarbonate having a relatively low MVR such as at most 8 cc/10 min determined in accordance with ISO 1133 (300° C., 1.2 kg).

### Cookie Value (a*)

The cookie value (a* value) is determined by means of the so called cookie test wherein 10 gram of polycarbonate is subjected to a heat aging test by placing said amount in an aluminum baking tray used for cookie baking and having a diameter of about 7 cm. The “cookie test” is an internal test for quickly determining the heat resistance properties of polycarbonate materials.

The trays were placed in an oven under normal atmosphere at a temperature of 250° C. for a duration of 120 minutes. The polycarbonate would melt and thereby form a disc-shaped plaque at the bottom of the cookie tray. The “cookie value”, i.e. the a* value of this plaque, when cooled down to room temperature, was measured in accordance with standard ASTM D1925. The reported a* value is the numerical average of the a* value measured on three different plaques.

The present invention will be further elucidated based on the following non-limiting examples.

### Materials

TABLE 1

| | |
|---|---|
| PC | Melt polycarbonate having a weight |
| | average molecular weight of about |
| | 57,000 g/mol (measured with GPC |
| | using polystyrene standards) and a |
| | MVR of 6 cc/10 min as determined |
| | in accordance with ISO 1133 (300° C., |
| | 1.2 kg). The PC does not contain any additive. |
| BuTos | n-butyl tosylate, used as a catalyst quencher |
| UV1 | 2-(2′-hydroxy-5′-(1,1,3,3- |
| | tetramethylbutyl)phenyl)benzotriazole |
| | commercially available as Cyasorb UV5411 |
| | and having CAS# 3147-75-9 |
| UV2 | 2-(2H-Benzotriazol-2-yl)-4,6-bis(1- |
| | methyl-1-phenylethyl)phenol |
| | commercially available as Tinuvin |
| | 234 and having CAS# 70321-86-7 |
| UV3 | 2,2′-Methylenebis[6-(2H-benzotriazol- |
| | 2-yl)-4-(1,1,3,3-tetramethylbutyl)phenol] |
| | commercially available as Tinuvin 360 and |
| | having CAS # 103597-45-1 |

The following compositions, all based on the same polycarbonate (PC), were prepared and subjected to the Cookie test. The reported value is the numerical average of three measurements. Table 2 shows the cookie value (a*) for compositions containing UV1 as the UV stabiliser.

TABLE 2

| | | UV1 | a* |
|---|---|---|---|
| | BuTos | (5411) | (“Cookie”) |
| E1 | 0 | 0 | −0.356 |
| E2 | 0 | 1000 | −0.344 |
| E3 | 0 | 1500 | −0.298 |
| E4 | 0 | 2000 | −0.396 |
| E5 | 0 | 2500 | −0.443 |
| E6 | 0 | 3000 | −0.421 |
| E7 | 1 | 0 | −0.036 |
| E8 | 1 | 1000 | −0.107 |
| E9 | 1 | 1500 | −0.144 |
| E10 | 1 | 2000 | −0.229 |
| E11 | 1 | 2500 | −0.206 |
| E12 | 1 | 3000 | −0.258 |
| E13 | 2 | 0 | 0.018 |
| E14 | 2 | 1000 | −0.106 |
| E15 | 2 | 1500 | −0.220 |
| E16 | 2 | 2000 | −0.200 |
| E17 | 2 | 2500 | −0.214 |
| E18 | 2 | 3000 | −0.219 |

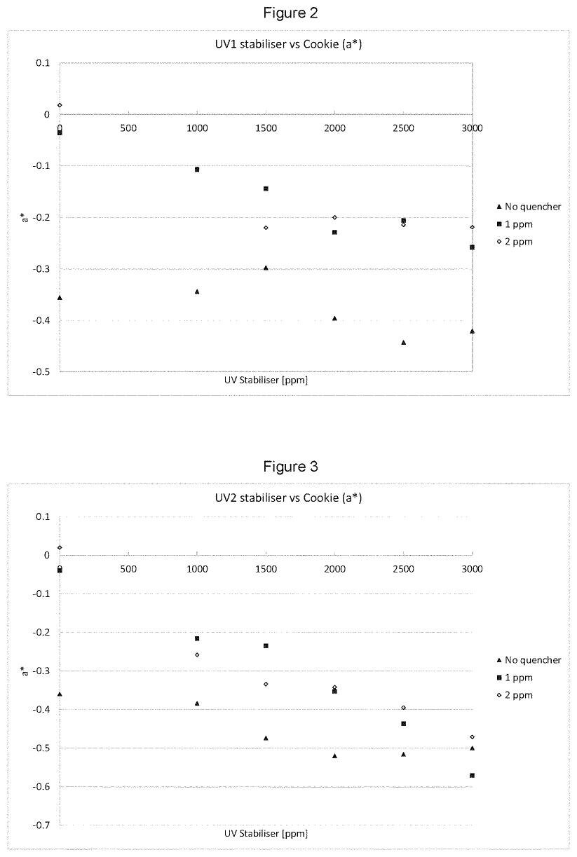

A graph of this data can be found in FIG. 2.

From the data it can be observed that, for compositions not containing a UV additive, the a* value increases upon increasing amount of quencher that is added to the polycarbonate. It can further be observed that the addition of the UV1 additive allows the increase in a* value as a result of the quencher addition to be mitigated at least in part.

Similar effects are observed for UV2 and UV3 as shown in Tables 2 and 3 below.

TABLE 3

| | | UV2 | a* |
|---|---|---|---|
| | BuTos | (234) | (“Cookie”) |
| E19 | 0 | 0 | −0.356 |
| E20 | 0 | 1000 | −0.384 |
| E21 | 0 | 1500 | −0.474 |
| E22 | 0 | 2000 | −0.520 |
| E23 | 0 | 2500 | −0.516 |
| E24 | 0 | 3000 | −0.500 |
| E25 | 1 | 0 | −0.036 |
| E26 | 1 | 1000 | −0.216 |
| E27 | 1 | 1500 | −0.235 |
| E28 | 1 | 2000 | −0.353 |
| E29 | 1 | 2500 | −0.436 |
| E30 | 1 | 3000 | −0.571 |
| E31 | 2 | 0 | 0.018 |
| E32 | 2 | 1000 | −0.258 |
| E33 | 2 | 1500 | −0.334 |
| E34 | 2 | 2000 | −0.342 |
| E35 | 2 | 2500 | −0.395 |
| E36 | 2 | 3000 | −0.471 |

A graph of this data can be found in FIG. 3.

TABLE 3

| | | UV3 | a* |
|---|---|---|---|
| | BuTos | (360) | (“Cookie”) |
| E37 | 0 | 0 | −0.356 |
| E38 | 0 | 1000 | −0.530 |
| E39 | 0 | 1500 | −0.692 |
| E40 | 0 | 2000 | −0.751 |
| E41 | 0 | 2500 | −0.803 |
| E42 | 0 | 3000 | −1.21 |
| E43 | 1 | 0 | −0.036 |
| E44 | 1 | 1000 | −0.40 |
| E45 | 1 | 1500 | −0.55 |
| E46 | 1 | 2000 | −0.70 |
| E47 | 1 | 2500 | −0.76 |
| E48 | 1 | 3000 | −0.89 |
| E49 | 2 | 0 | 0.018 |
| E50 | 2 | 1000 | −0.15 |
| E51 | 2 | 1500 | −0.60 |
| E52 | 2 | 2000 | −0.70 |
| E53 | 2 | 2500 | −0.74 |
| E54 | 2 | 3000 | −0.81 |

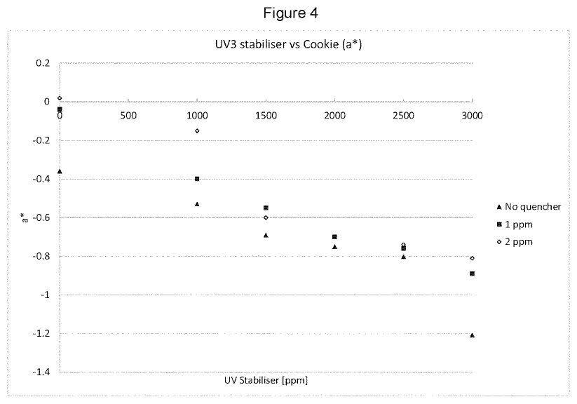

A graph of this data can be found in FIG. 4.

The experimental data shows that ultraviolet stabilising compounds comprising at least one benzotriazole group can be used successfully as a heat stabiliser in polycarbonate manufactured by means of a melt transesterification process comprising reacting diaryl carbonate and bisphenol catalysed by a catalyst and quenching the catalyst with a quencher. The addition of such a UV stabiliser reduces the cookie value, indicative for an improved yellowing of the polycarbonate upon heat aging of the polycarbonate.

1. A method of manufacturing polycarbonate by means of a melt transesterification process comprising
reacting diaryl carbonate and bisphenol catalysed by a catalyst,
quenching the catalyst with a quencher, and
adding an ultraviolet stabilising compound comprising at least one benzotriazole group as a heat stabilizer.

2. A method of manufacturing an article comprising polycarbonate manufactured by means of a melt transesterification process comprising
reacting diaryl carbonate and bisphenol catalysed by a catalyst,
quenching the catalyst with a quencher, and
adding an ultraviolet stabilising compound comprising at least one benzotriazole group as an additive,
wherein the article has an a* value which is lower compared to an otherwise identical polycarbonate not comprising said ultraviolet stabilising compound.

3. A method for the manufacture of melt polycarbonate comprising:
reacting diaryl carbonate and bisphenol catalysed by a catalyst in at least two consecutive reactors so as to form a stream of molten polycarbonate, adding a quencher and an ultraviolet stabilising compound comprising at least one benzotriazole group to said molten stream of polycarbonate,
extruding the molten stream of polycarbonate into one or more strands
optionally cooling the one or more strands
pelletising the strands,
wherein the molar ratio of quencher to catalyst is from 1.0 to 5.0, and wherein the amount of said ultraviolet stabilising compound is from 500 to 5000 ppm by weight on the basis of the weight of the polycarbonate.

4. The method of claim 3 wherein the polycarbonate has an a* value which is lower compared to a polycarbonate manufactured with an otherwise identical process, yet wherein no ultraviolet stabilising compound is added.

5. The method of claim 3 wherein the polycarbonate is fed from a final reactor to an extruder and wherein the quencher is added in said final reactor and/or said extruder.

6. The method of claim 3 wherein the ultraviolet stabilising compound is added to the extruder.

7. The method of claim 3 wherein the ultraviolet stabilising compound is selected from the group consisting of 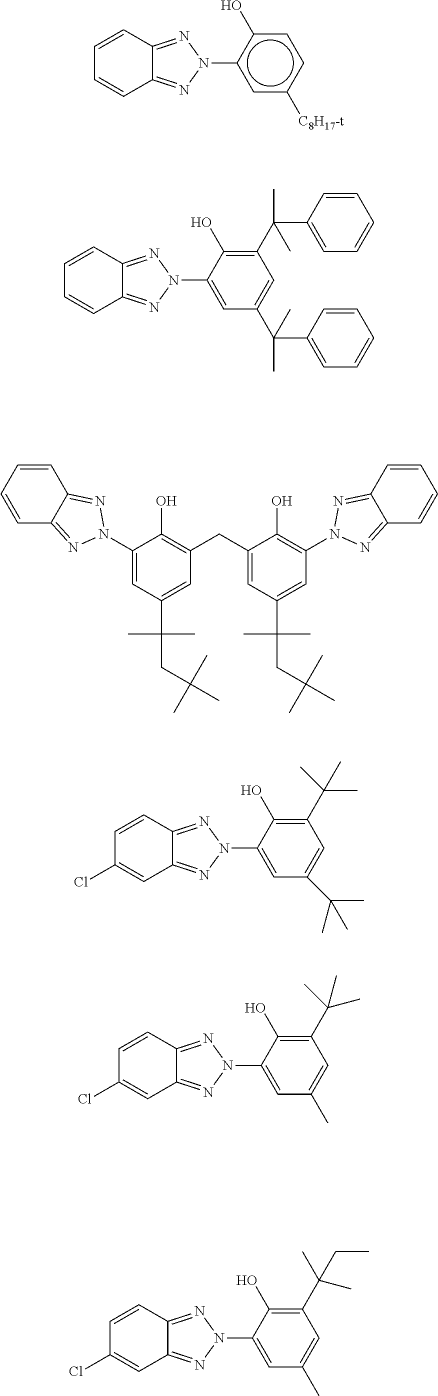
and combinations of two or more of these compounds.

8. The method of claim 3 wherein the amount of quencher is at most 1.8 ppm, based on the weight of the polycarbonate.

9. The method of claim 3 wherein the quencher comprises butyl tosylate.

10. The method of claim 3 wherein no acid stabiliser is added to the polycarbonate.

11. The method of claim 3 wherein the polycarbonate is fed from a final reactor to an extruder and wherein an amount of recycled polycarbonate is combined with said polycarbonate in said extruder, said ultraviolet stabilising compound being contained, at least in part, in said recycled polycarbonate.

12. The method of claim 3 wherein the bisphenol consists of bisphenol A and the diaryl carbonate consists of diphenyl carbonate.

13. An article comprising or consisting of the polycarbonate obtained by the method of claim 3.

14. A method for the manufacture of the article of claim 13 comprising
manufacturing the polycarbonate and
moulding the polycarbonate at a temperature of at least 280°.
